(19) United States
(12) Patent Application Publication
(10) Pub. No.: US 2016/0210019 A1
(43) Pub. Date: Jul. 21, 2016

(54) DESKTOP ICON PROJECTION MANAGING METHOD AND ELECTRONIC EQUIPMENT

(71) Applicants: HISENSE MOBILE COMMUNICATIONS TECHNOLOGY CO.,LTD., Shandong (CN); HISENSE USA CORPORATION, Suwanee, GA (US); HISENSE INTERNATIONAL CO.,LTD., Shandong (CN)

(72) Inventors: Peipei Liu, Shandong (CN); Peng Zhang, Shandong (CN)

(21) Appl. No.: 14/803,245

(22) Filed: Jul. 20, 2015

(30) Foreign Application Priority Data
Jan. 20, 2015 (CN) 201510029236.2

(51) Int. Cl. G06F 3/0481; G06F 3/0482

(52) U.S. Cl. CPC G06F 3/04817; G06F 3/0482

(57) ABSTRACT

A desktop icon projection managing method includes: when a desktop icon projection switch of an electronic equipment is turned on, acquiring, by the electronic equipment, desktop icon projection parameters of desktop icons on the desktop of the electronic equipment; judging whether a desktop icon backplane switch of the electronic equipment is turned on by the electronic equipment; when the desktop icon backplane switch is turned on by the electronic equipment, making the same projection for each desktop icon on a desktop icon backplane of each desktop icon according to the desktop icon projection parameters, wherein the desktop icon backplane of each desktop icon is the same; and when the desktop icon backplane switch is not turned on by the electronic equipment, respectively making the corresponding projection for each desktop icon according to the desktop icon projection parameters.

### CROSS-REFERENCES TO RELATED APPLICATIONS

This application claims priority to Chinese patent application No. 201510029236.2, filed with the State Intellectual Property Office of People's Republic of China on Jan. 20, 2015, the content of which is incorporated herein by reference in its entirety.

### FIELD

The present disclosure relates to the field of an electronic equipment, and particularly relates to a desktop icon projection managing method and electronic equipment.

### BACKGROUND

With the popularization of smart phones and the improvement of screen quality, the requirement of users for the display effect of desktop software is gradually improved, and the display application serving as one of the most important functions of the desktop software is very important for user experience. However, when the colors of a desktop icon and a desktop wallpaper of portable electronic equipment (e.g. a smart phone, a tablet personal computer, etc.) are superposed, the desktop icon is difficult to distinguish.

### SUMMARY

Embodiments of the present disclosure adopt the following technical scheme:

In one aspect, a desktop icon projection managing method, applied to an electronic equipment, is provided, and the method includes:

when a desktop icon projection switch of the electronic equipment is turned on, acquiring, by the electronic equipment, desktop icon projection parameters of desktop icons on the desktop of the electronic equipment;

judging whether a desktop icon backplane switch of the electronic equipment is turned on by the electronic equipment;

when the desktop icon backplane switch is turned on by the electronic equipment, making the same projection for each desktop icon on a desktop icon backplane of each desktop icon, according to the desktop icon projection parameters, herein the desktop icon backplane of each desktop icon is the same;

when the desktop icon backplane switch is not turned on by the electronic equipment, respectively making a corresponding projection for each desktop icon, according to the desktop icon projection parameters; and presenting the desktop icons and projections by a display.

In another aspect, an electronic equipment is provided, and the equipment includes:

a display, configured to present desktop icons and desktop icon projections;

an acquiring component, configured to, when a desktop icon projection switch of the electronic equipment is turned on, acquire desktop icon projection parameters of desktop icons on the desktop of the electronic equipment;

a judging component, configured to judge whether a desktop icon backplane switch of the electronic equipment is turned on by the electronic equipment;

a first projection making component, configured to, if the judging component judges that the desktop icon backplane switch is turned on by the electronic equipment, make the same projection for each desktop icon on a desktop icon backplane of each desktop icon according to the desktop icon projection parameters acquired by the acquiring component, herein the desktop icon backplane of each desktop icon is the same; and

a second projection making component, configured to, if the judging component judges that the desktop icon backplane switch is not turned on by the electronic equipment, respectively make a corresponding projection for each desktop icon, according to the desktop icon projection parameters acquired by the acquiring component.

### BRIEF DESCRIPTION OF THE DRAWINGS

To illustrate the technical schemes in embodiments of the present disclosure more clearly, a brief introduction on the drawings in embodiments of the present disclosure is given below. Apparently, the drawings in the description below are merely some of the embodiments of the present disclosure, based on which other drawings may be obtained by those of ordinary skill in the art without any inventive effort.

FIG. 1 is a flow diagram of a desktop icon projection managing method provided by an embodiment of the present disclosure;

FIG. 2 is a flow diagram of another desktop icon projection managing method provided by an embodiment of the present disclosure;

FIG. 3 is a structural schematic diagram of an electronic equipment provided by an embodiment of the present disclosure;

FIG. 4 is a structural schematic diagram of another electronic equipment provided by an embodiment of the present disclosure;

FIG. 5 is a structural schematic diagram of an electronic equipment provided by an embodiment of the present disclosure; and

FIG. 6 is a schematic diagram of the decomposition of the desktop icon, the backplane of desktop icon and the desktop icon projection.

### DETAILED DESCRIPTION OF THE EMBODIMENTS

A clear and complete description of the technical schemes in embodiments of the present disclosure will be given below, in combination with the drawings in embodiments of the present disclosure. Apparently, the described embodiments are merely a part, but not all, of the embodiments of the present disclosure. All of other embodiments, obtained by those of ordinary skill in the art based on the embodiments of the present disclosure without any inventive effort, fall into the protection scope of the present disclosure.

Embodiments of the present disclosure provide a desktop icon projection managing method and electronic equipment. A desktop icon projection switch and a desktop icon backplane switch are installed in the electronic equipment, so that the electronic equipment is able to simultaneously support two projection generating methods by controlling turn-on and turn-off of the desktop icon projection switch and the desktop icon backplane switch, then a user can select different projection generating methods for different desktop wallpapers or different application scenarios, and different desktop icon projections are made for desktop icons in different desktop wallpapers, so that the flexibility of the electronic equipment generating the desktop icon projections is improved and the user experience is also improved.

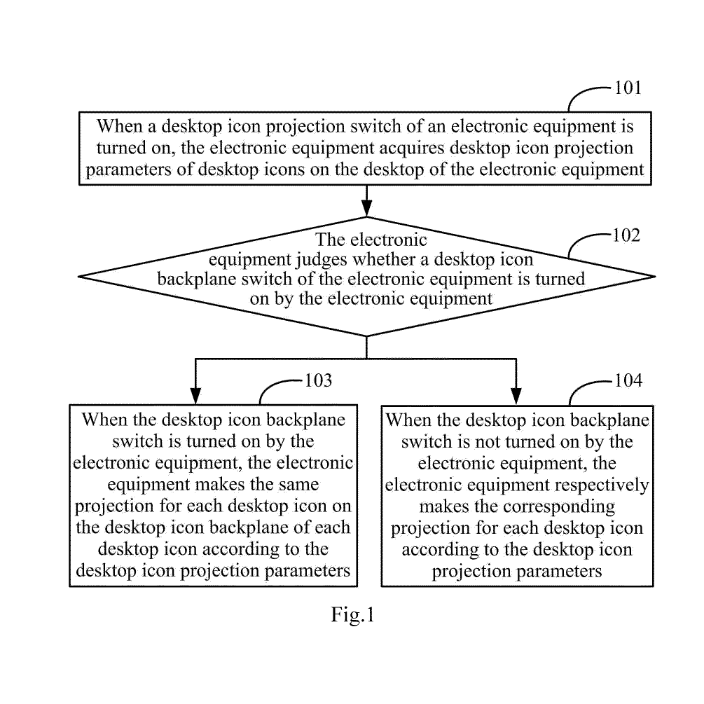

Embodiments of the present disclosure provide a desktop icon projection managing method, as shown in FIG. 1, and the method particularly includes the following operations.

101: when a desktop icon projection switch of an electronic equipment is turned on, the electronic equipment acquires desktop icon projection parameters of desktop icons on the desktop of the electronic equipment.

The above-mentioned electronic equipment may be a portable, pocket or handheld electronic equipment, e.g. a smart phone, a tablet personal computer, a personal digital assistant, etc. The above-mentioned desktop icon projection parameters include but not limited to at least one of permeation value, resolution, offset value and radius of a desktop icon projection.

102: the electronic equipment judges whether a desktop icon backplane switch of the electronic equipment is turned on by the electronic equipment.

The desktop icon backplane switch and the desktop icon projection switch are simultaneously added in the electronic equipment of embodiments of the present disclosure. A user may turn on or off the desktop icon projection switch, according to different application scenarios or different desktop wallpapers, to select whether to generate a desktop icon projection for a desktop icon in the desktop wallpaper, and turn on or off the desktop icon backplane switch, to select different projection generating methods for generating different desktop icon projections for desktop icons in different desktop wallpapers.

When the desktop icon backplane switch is turned on by the electronic equipment, then the flow proceeds to the operation 103, and when the desktop icon backplane switch is not turned on by the electronic equipment, then the flow proceeds to the operation 104.

103: when the desktop icon backplane switch is turned on by the electronic equipment, the electronic equipment makes the same projection for each desktop icon on the desktop icon backplane of each desktop icon, according to the desktop icon projection parameters.

The desktop icon backplane of each desktop icon is the same in shape and size.

Exemplarily, when the pattern of the current desktop wallpaper of the electronic equipment is complex, it is difficult for a user to distinguish the desktop wallpaper and the desktop icons, due to the complexity of the pattern of the desktop wallpaper, then the electronic equipment needs to generate a projection with a better projection effect for each desktop icon in the desktop of the electronic equipment, and the user may select to turn on the icon backplane switch to generate the projection in the same shape for each desktop icon, so that the projection effect is improved.

104: when the desktop icon backplane switch is not turned on by the electronic equipment, the electronic equipment respectively makes the corresponding projection for each desktop icon, according to the desktop icon projection parameters.

The desktop icons and projections are presented (or displayed) by a display. The display may be a part of the electronic equipment.

Exemplarily, when the pattern of the current desktop wallpaper of the electronic equipment has a single color and is simple, the electronic equipment only needs to add a small range of shadow for the edge part of each desktop icon on the desktop of the electronic equipment, so that the desktop wallpaper and the desktop icons may be easily distinguished. Moreover, when the desktop wallpaper has a single color and a simple pattern, the shadow is relatively obvious, so that the overall desktop is not aesthetic enough when the area of the shadow is excessively added. At the moment, the user may select not to turn on the desktop icon backplane switch, but directly turn on a desktop icon shadow switch, to indicate the electronic equipment to make a projection, in the same shape as each desktop icon, for each desktop icon on the desktop of the electronic equipment, by using a software algorithm, according to the desktop icon projection parameters, that is, making a small range of shadow for the desktop icon.

According to the desktop icon projection managing method provided by the embodiment of the present disclosure, the desktop icon projection switch and the desktop icon backplane switch are installed in the electronic equipment, so that the electronic equipment may simultaneously support two projection generating methods by controlling turn-on and turn-off of the desktop icon projection switch and the desktop icon backplane switch, then different projection generating methods may be selected by a user for different desktop wallpapers or different application scenarios, and different desktop icon projections are made for the desktop icons in different desktop wallpapers, so that the flexibility of the electronic equipment generating the desktop icon projections is improved and the user experience is also improved.

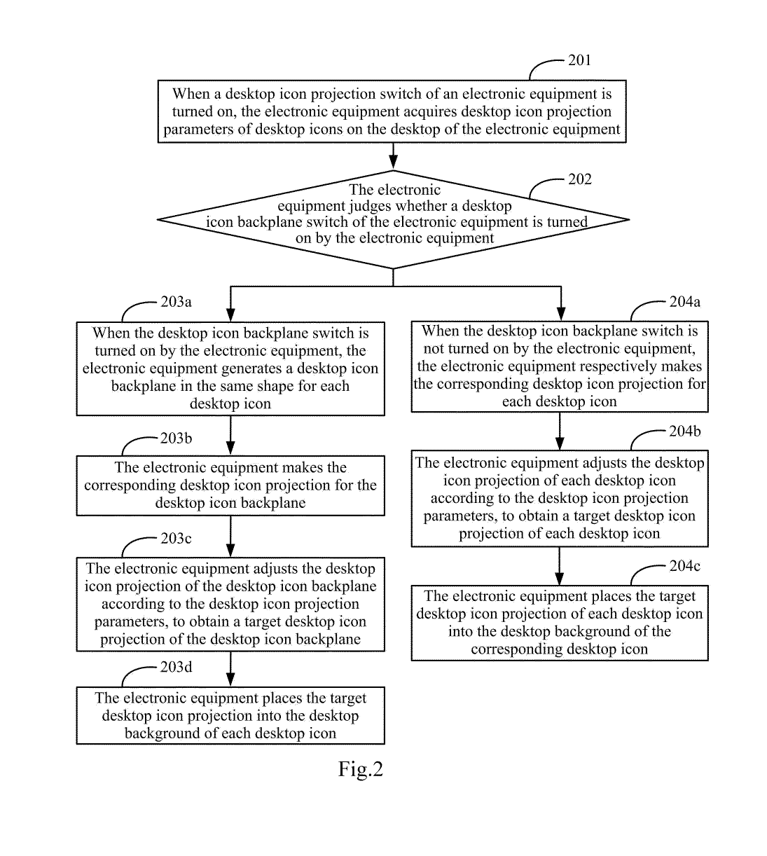

Embodiments of the present disclosure provide a desktop icon projection managing method, as shown in FIG. 2, and the method particularly includes the following operations:

201: when a desktop icon projection switch of an electronic equipment is turned on, the electronic equipment acquires desktop icon projection parameters of desktop icons on the desktop of the electronic equipment.

202: the electronic equipment judges whether a desktop icon backplane switch of the electronic equipment is turned on by the electronic equipment.

When the desktop icon backplane switch is turned on by the electronic equipment, then the flow proceeds to the operation 203, and when the desktop icon backplane switch is not turned on by the electronic equipment, then the flow proceeds to the operation 204.

203: when the desktop icon backplane switch is turned on by the electronic equipment, the electronic equipment makes the same projection for each desktop icon on the desktop icon backplane of each desktop icon, according to the desktop icon projection parameters.

Alternatively, operation 203 may include the following operations:

203a: when the desktop icon backplane switch is turned on by the electronic equipment, the electronic equipment generates a desktop icon backplane in the same shape for each desktop icon.

203b: the electronic equipment makes the corresponding desktop icon projection for the desktop icon backplane.

203c: the electronic equipment adjusts the desktop icon projection of the desktop icon backplane, according to the desktop icon projection parameters, to obtain a target desktop icon projection of the desktop icon backplane.

203d: the electronic equipment places the target desktop icon projection into the desktop background of each desktop icon.

204: when the desktop icon backplane switch is not turned on by the electronic equipment, the electronic equipment respectively makes the corresponding projection for each desktop icon, according to the desktop icon projection parameters.

Alternatively, operation 204 may include the following operations:

204a: when the desktop icon backplane switch is not turned on by the electronic equipment, the electronic equipment respectively makes the corresponding desktop icon projection for each desktop icon.

The electronic equipment may draw a desktop icon projection corresponding to the shape of each desktop icon by using a software algorithm according to the shape of the desktop icon.

204b: the electronic equipment adjusts the desktop icon projection of each desktop icon according to the desktop icon projection parameters, to obtain a target desktop icon projection of each desktop icon.

204c: the electronic equipment places the target desktop icon projection of each desktop icon into the desktop background of the corresponding desktop icon.

Alternatively, before operation 201, the method further includes:

201a: the electronic equipment updates the icon projection parameters of the electronic equipment according to a user instruction;

or,

201b: the electronic equipment acquires desktop background parameters of each desktop icon coverage area, and updates the icon projection parameters of the electronic equipment, according to the desktop background parameters of each desktop icon coverage area.

It should be noted that, for the process of operation 201 to operation 204 in an embodiment of the present disclosure, reference may be made to the detailed description of operation 101 to operation 104 in an embodiment, which is not redundantly described herein.

According to the desktop icon projection managing method provided by the embodiment of the present disclosure, the desktop icon projection switch and the desktop icon backplane switch are installed in the electronic equipment, so that the electronic equipment may simultaneously support two projection generating methods, by controlling turn-on and turn-off of the desktop icon projection switch and the desktop icon backplane switch, then different projection generating methods may be selected by a user for different desktop wallpapers or different application scenarios, and different desktop icon projections are made for the desktop icons in different desktop wallpapers, so that the flexibility of the electronic equipment generating the desktop icon projections is improved and the user experience is also improved.

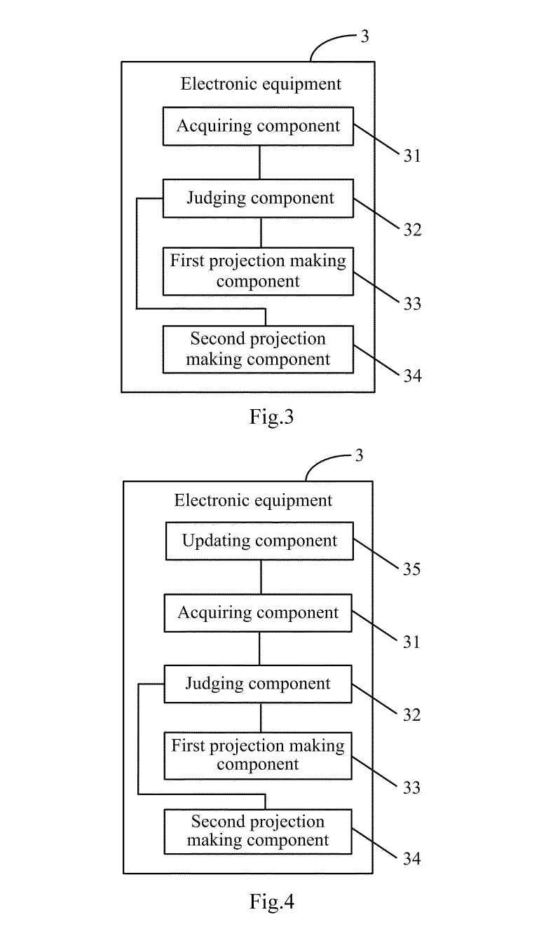

An embodiment of the present disclosure provides an electronic equipment. The electronic equipment is used for implementing the above-mentioned desktop icon projection managing method. As shown in FIG. 3, the electronic equipment 3 includes a display, an acquiring component 31, a judging component 32, a first projection making component 33 and a second projection making component 34.

The display is configured to present desktop icons and desktop icon projection.

The acquiring component 31 is configured to acquire desktop icon projection parameters of desktop icons on the desktop of the electronic equipment, if a desktop icon projection switch of the electronic equipment is turned on.

The judging component 32 is configured to judge whether a desktop icon backplane switch of the electronic equipment is turned on by the electronic equipment.

The first projection making component 33 is configured to, if the judging component 32 judges that the desktop icon backplane switch is turned on by the electronic equipment, make the same projection for each desktop icon on a desktop icon backplane of each desktop icon, according to the desktop icon projection parameters acquired by the acquiring component 31.

The desktop icon backplane of each desktop icon is the same.

The second projection making component 34 is configured to, if the judging component 32 judges that the desktop icon backplane switch is not turned on by the electronic equipment, respectively make the corresponding projection for each desktop icon according to the desktop icon projection parameters acquired by the acquiring component 31.

Alternatively, the first projection making component 33 is configured to: if the judging component 32 judges that the desktop icon backplane switch is turned on by the electronic equipment, generate a desktop icon backplane in the same shape for each desktop icon; make the corresponding desktop icon projection for the desktop icon backplane; adjust the desktop icon projection of the desktop icon backplane according to the desktop icon projection parameters acquired by the acquiring component 31, to obtain a target desktop icon projection of the desktop icon backplane; and place the target desktop icon projection into the desktop background of each desktop icon.

Alternatively, the second projection making component 34 is configured to: if the judging component 32 judges that the desktop icon backplane switch is not turned on by the electronic equipment, respectively make the corresponding desktop icon projection for each desktop icon; adjust the desktop icon projection of each desktop icon according to the desktop icon projection parameters acquired by the acquiring component 31, to obtain a target desktop icon projection of each desktop icon; and place the target desktop icon projection of each desktop icon into the desktop background of the corresponding desktop icon.

Alternatively, as shown in FIG. 4, the electronic equipment further includes: an updating component 35, herein

the updating component 35 is configured to update the icon projection parameters of the electronic equipment according to a user instruction; or, acquire desktop background parameters of each desktop icon coverage area, and update the icon projection parameters of the electronic equipment, according to the desktop background parameters of each desktop icon coverage area.

Alternatively, the desktop icon projection parameters include permeation value and resolution of a desktop icon projection.

According to the electronic equipment provided by the embodiment of the present disclosure, the desktop icon projection switch and the desktop icon backplane switch are installed in the electronic equipment, so that the electronic equipment may simultaneously support two projection generating methods by controlling turn-on and turn-off of the desktop icon projection switch and the desktop icon backplane switch, then different projection generating methods may be selected by a user for different desktop wallpapers or different application scenarios, and different desktop icon projections are made for the desktop icons in different desktop wallpapers, so that the flexibility of the electronic equipment generating the desktop icon projections is improved and the user experience is also improved.

Those skilled in the art shall clearly understand that, for the purpose of convenience and briefness in description, the division of each above-mentioned functional unit is taken as an example for illustration. In practical application, the above-mentioned functions may be completed by different functional units according to needs, namely the internal structure of the device is divided into different functional units, to complete all of or part of the above-described functions. For the particular working processes of the above-described electronic equipment and modules, reference may be made to the corresponding processes in embodiments of the aforementioned methods, which are not described redundantly herein. In addition, in various embodiments of the present application, the functional modules may be integrated in a processing unit, or the modules may separately and physically exist, or two or more modules may be integrated in one module. The above-mentioned integrated modules may be implemented in the form of hardware or software functional units.

An embodiment of the present disclosure provides an electronic equipment, including: a display; one or more processors; and a memory with computer-readable program codes stored therein, and the computer-readable program codes are executed, by the one or more processors, to implement:

when a desktop icon projection switch of the electronic equipment is turned on, acquiring desktop icon projection parameters of desktop icons on a desktop of the electronic equipment;

judging whether a desktop icon backplane switch of the electronic equipment is turned on by the electronic equipment;

when the desktop icon backplane switch is turned on by the electronic equipment, making a same projection, for each desktop icon on a desktop icon backplane of each desktop icon, according to the desktop icon projection parameters; and

when the desktop icon backplane switch is not turned on by the electronic equipment, respectively making a corresponding projection for each desktop icon, according to the desktop icon projection parameters; and

the display is controlled by the processor to present the desktop icons and projections.

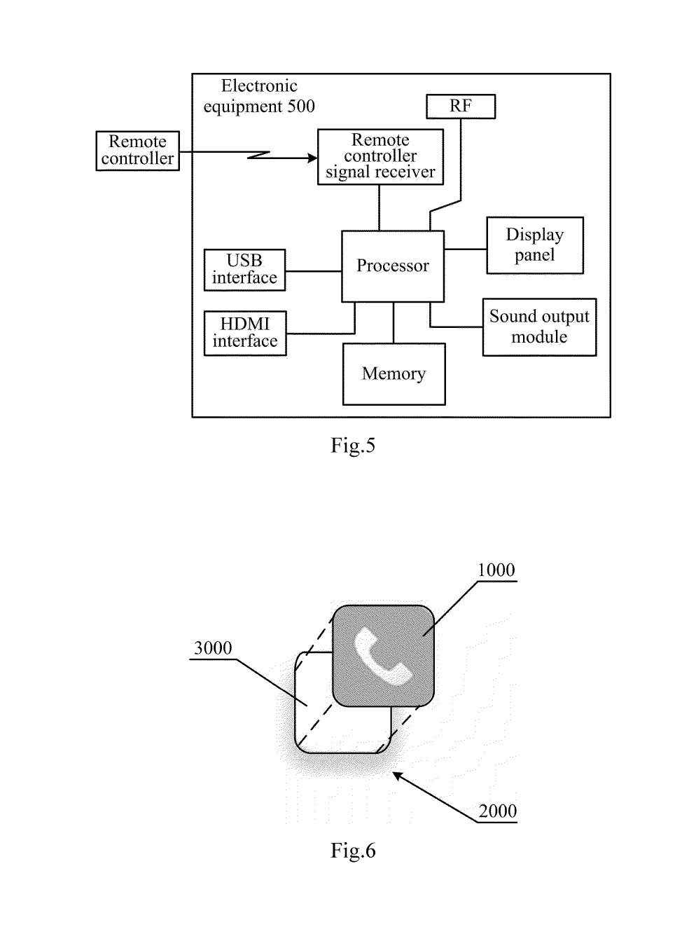

As shown in FIG. 5, the electronic equipment 500 may include a memory, an input unit, an output unit, one or more processors and the like. It could be understood by those skilled in the art that, the electronic equipment is not limited to the structure of the electronic equipment given by embodiments of the present disclosure, and may include more or less components or combine some components or have different component arrangement.

The memory may be used for storing software programs and modules, and the processors may execute various functional applications and process data by operating the software programs and modules stored in the memory. The memory may be a high-speed random access memory or a nonvolatile memory, e.g. at least one disk storage device, a flash device or other volatile solid-state storage device. In addition, the memory may also include a memory controller, for providing access to the memory for the processors and the input unit.

The processor is a control center of the electronic equipment, is connected with each part of the whole electronic equipment through various interfaces and circuits, and is configured to execute various functions of the electronic equipment and process data, by operating or executing the software programs and/or modules stored in the memory and calling the data stored in the memory, so as to monitor the whole electronic equipment. Alternatively, the processor may include one or more processing cores. Alternatively, the processor may integrate an application processor and a modulation-demodulation processor, herein the application processor is mainly used for processing an operating system, a user interface, application programs and the like, and the modulation-demodulation processor is mainly used for processing wireless communication. It should be understood that, the modulation-demodulation processor may also not be integrated in the processor.

The electronic equipment may include a receiver, a high-definition multimedia interface, a USB port, an audio-video input structure and other input unit, and an input unit may further include a remote controller receiver for receiving signals transmitted by a remote controller. In addition, the input unit may further include a touch-sensitive surface and other input equipment; the touch-sensitive surface may be implemented by adopting multiple types of resistance, capacitance, infrared, surface acoustic wave and the like; and the other input equipment may include but not limited to one or more of a physical keyboard, functional keys (such as a volume control key, a switch key and the like), a trackball, a mouse, an operating lever and the like.

The output unit is configured to output sound signals, video signals, alarm signals, vibration signals and the like. The output unit may include a projection module, a sound output module and the like. The projection module may be used for making projections according to the information input by a user or the information provided to a user.

The electronic equipment may further include an Radio Frequency (RF) circuit. The RF circuit may be configured to receive and transmit signals. Generally, the RF circuit includes but not limited to an antenna, at least one amplifier, a tuner, one or more oscillators, a subscriber identity module (SIM) card, a transceiver, a coupler, an Low Noise Amplifier (LNA), a duplexer and the like. In addition, the electronic equipment may further include a Bluetooth module and the like.

Moreover, the electronic equipment may further include a wireless fidelity (WiFi) module (not shown in the figure). WiFi belongs to a short-distance wireless transmission technology, and the electronic equipment may assist the user in transceiving E-mails, browsing webs, accessing streaming media and the like through the WiFi module, so that the WiFi module provides a wireless broadband Internet access for the user. However, it could be understood that, the WiFi module is not a necessary composition of the electronic equipment, and may completely be removed according to needs without changing the scope of the essence of the present disclosure.

As illustrated by FIG. 6, an embodiment of the present disclosure provides a schematic diagram of the decomposition of the desktop icon, the backplane of desktop icon and the desktop icon projection. In FIG. 6, 1000 represents the desktop icon, 2000 represents the projection of the desktop icon, and 3000 represents the backplane of desktop icon. Projections and backplanes of desktop icons are not limited to the patterns illustrated by FIG. 6, but may alternatively take other proper patterns.

Those skilled in the art shall appreciate that the embodiments of the invention can be embodied as a method, a system or a computer program product. Therefore the invention can be embodied in the form of an all-hardware embodiment, an all-software embodiment or an embodiment of software and hardware in combination. Furthermore the invention can be embodied in the form of a computer program product embodied in one or more computer useable storage mediums (including but not limited to a disk memory, a CD-ROM, an optical memory, etc.) in which computer useable program codes are contained.

The invention has been described in a flow chart and/or a block diagram of the method, the device (system) and the computer program product according to the embodiments of the invention. It shall be appreciated that respective flows and/or blocks in the flow chart and/or the block diagram and combinations of the flows and/or the blocks in the flow chart and/or the block diagram can be embodied in computer program instructions. These computer program instructions can be loaded onto a general-purpose computer, a specific-purpose computer, an embedded processor or a processor of another programmable data processing device to produce a machine so that the instructions executed on the computer or the processor of the other programmable data processing device create means for performing the functions specified in the flow(s) of the flow chart and/or the block(s) of the block diagram.

These computer program instructions can also be stored into a computer readable memory capable of directing the computer or the other programmable data processing device to operate in a specific manner so that the instructions stored in the computer readable memory create an article of manufacture including instruction means which perform the functions specified in the flow(s) of the flow chart and/or the block(s) of the block diagram.

These computer program instructions can also be loaded onto the computer or the other programmable data processing device so that a series of operational steps are performed on the computer or the other programmable data processing device to create a computer implemented process so that the instructions executed on the computer or the other programmable data processing device provide steps for performing the functions specified in the flow(s) of the flow chart and/or the block(s) of the block diagram.

The above embodiments are merely used for illustrating the technical schemes of the present application, rather than limiting the present application; although the present application is illustrated in detail with reference to the aforementioned embodiments, those of ordinary skill in the art shall understand that modifications still may be made to the technical schemes recorded in the aforementioned embodiments, or equivalent substitutions may be made to a part of technical features thereof; and these modifications or substitutions do not make the essence of the corresponding technical schemes depart from the spirit and scope of the technical schemes of embodiments of the present application.

1. A desktop icon projection managing method, applied to an electronic equipment, comprising:
when a desktop icon projection switch of the electronic equipment is turned on, acquiring desktop icon projection parameters of desktop icons on a desktop of the electronic equipment;
judging whether a desktop icon backplane switch of the electronic equipment is turned on by the electronic equipment;
when the desktop icon backplane switch is turned on by the electronic equipment, making a same projection, for each desktop icon on a desktop icon backplane of each desktop icon, according to the desktop icon projection parameters;
when the desktop icon backplane switch is not turned on by the electronic equipment, respectively making a corresponding projection for each desktop icon, according to the desktop icon projection parameters; and
presenting the desktop icons and projections by a display.

2. The method according to claim 1, wherein when the desktop icon backplane switch is turned on by the electronic equipment, making the same projection for each desktop icon on a desktop icon backplane of each desktop icon according to the desktop icon projection parameters, comprises:
when the desktop icon backplane switch is turned on by the electronic equipment, generating a desktop icon backplane in a same shape for each desktop icon;
making the corresponding desktop icon projection for the desktop icon backplane;
adjusting the desktop icon projection of the desktop icon backplane, according to the desktop icon projection parameters, to obtain a target desktop icon projection of the desktop icon backplane; and
placing the target desktop icon projection into the desktop background of each desktop icon.

3. The method according to claim 1, wherein when the desktop icon backplane switch is not turned on by the electronic equipment, respectively making the corresponding projection for each desktop icon according to the desktop icon projection parameters, comprises:
when the desktop icon backplane switch is not turned on by the electronic equipment, respectively making a corresponding desktop icon projection for each desktop icon;
adjusting the desktop icon projection of each desktop icon, according to the desktop icon projection parameters, to obtain a target desktop icon projection of each desktop icon; and
placing the target desktop icon projection of each desktop icon into the desktop background of the corresponding desktop icon.

4. The method according to claim 1, wherein before the electronic equipment acquires desktop icon projection parameters of desktop icons on the desktop of the electronic equipment if a desktop icon projection switch of the electronic equipment is turned on, the method further comprises:
updating the icon projection parameters of the electronic equipment according to a user instruction; or
acquiring desktop background parameters of each desktop icon coverage area, and updating the icon projection parameters of the electronic equipment, according to the desktop background parameters of each desktop icon coverage area.

5. The method according to claim 1, wherein the desktop icon projection parameters comprise at least one of permeation value, resolution, offset value and radius of a desktop icon projection.

6. The method according to claim 2, wherein the desktop icon projection parameters comprise at least one of permeation value, resolution, offset value and radius of a desktop icon projection.

7. The method according to claim 3, wherein the desktop icon projection parameters comprise at least one of permeation value, resolution, offset value and radius of a desktop icon projection.

8. The method according to claim 4, wherein the desktop icon projection parameters comprise at least one of permeation value, resolution, offset value and radius of a desktop icon projection.

9. The method according to claim 5, wherein the desktop icon projection parameters comprise at least one of permeation value, resolution, offset value and radius of a desktop icon projection.

10. An electronic equipment, comprising:
a display, configured to present desktop icons and desktop icon projections;
an acquiring component, configured to, when a desktop icon projection switch of the electronic equipment is turned on, acquire desktop icon projection parameters of desktop icons on a desktop of the electronic equipment;
a judging component, configured to judge whether a desktop icon backplane switch of the electronic equipment is turned on by the electronic equipment;
a first projection making component, configured to, if the judging component judges that the desktop icon backplane switch is turned on by the electronic equipment, make a same projection, for each desktop icon on a desktop icon backplane of each desktop icon, according to the desktop icon projection parameters acquired by the acquiring component, wherein the desktop icon backplane of each desktop icon is the same; and
a second projection making component, configured to, if the judging component judges that the desktop icon backplane switch is not turned on by the electronic equipment, respectively make a corresponding projection for each desktop icon, according to the desktop icon projection parameters acquired by the acquiring component.

11. The electronic equipment according to claim 10, wherein the first projection making component is configured to:
if the judging component judges that the desktop icon backplane switch is turned on by the electronic equipment, generate a desktop icon backplane in a same shape for each desktop icon; make the corresponding desktop icon projection for the desktop icon backplane; adjust the desktop icon projection of the desktop icon backplane according to the desktop icon projection parameters acquired by the acquiring component, to obtain a target desktop icon projection of the desktop icon backplane; and place the target desktop icon projection into the desktop background of each desktop icon.

12. The electronic equipment according to claim 10, wherein the second projection making component is configured to:
if the judging component judges that the desktop icon backplane switch is not turned on by the electronic equipment, respectively make a corresponding desktop icon projection for each desktop icon; adjust the desktop icon projection of each desktop icon according to the desktop icon projection parameters acquired by the acquiring component, to obtain a target desktop icon projection of each desktop icon; and place the target desktop icon projection of each desktop icon into the desktop background of the corresponding desktop icon.

13. The electronic equipment according to claim 10, comprising: an updating component, configured to update the icon projection parameters of the electronic equipment according to a user instruction; or
acquire desktop background parameters of each desktop icon coverage area, and update the icon projection parameters of the electronic equipment, according to the desktop background parameters of each desktop icon coverage area.

14. The electronic equipment according to claim 10, wherein the desktop icon projection parameters comprise at least one of permeation value, resolution, offset value and radius of a desktop icon projection.

15. An electronic equipment, comprising:
a display;
one or more processors; and
a memory with computer-readable program codes stored therein, and the computer-readable program codes are executed, by the one or more processors, to implement:
when a desktop icon projection switch of the electronic equipment is turned on, acquiring desktop icon projection parameters of desktop icons on a desktop of the electronic equipment;
judging whether a desktop icon backplane switch of the electronic equipment is turned on by the electronic equipment;
when the desktop icon backplane switch is turned on by the electronic equipment, making a same projection, for each desktop icon on a desktop icon backplane of each desktop icon, according to the desktop icon projection parameters; and
when the desktop icon backplane switch is not turned on by the electronic equipment, respectively making a corresponding projection for each desktop icon, according to the desktop icon projection parameters; and
the display is controlled by the processor to present the desktop icons and projections.

16. The electronic equipment according to claim 15, wherein when the desktop icon backplane switch is turned on by the electronic equipment, making the same projection for each desktop icon on a desktop icon backplane of each desktop icon according to the desktop icon projection parameters, comprises:
when the desktop icon backplane switch is turned on by the electronic equipment, generating a desktop icon backplane in a same shape for each desktop icon;
making a corresponding desktop icon projection for the desktop icon backplane;
adjusting the desktop icon projection of the desktop icon backplane, according to the desktop icon projection parameters, to obtain a target desktop icon projection of the desktop icon backplane; and
placing the target desktop icon projection into the desktop background of each desktop icon.

17. The electronic equipment according to claim 15, wherein when the desktop icon backplane switch is not turned on by the electronic equipment, respectively making the corresponding projection for each desktop icon according to the desktop icon projection parameters, comprises:
when the desktop icon backplane switch is not turned on by the electronic equipment, respectively making the corresponding desktop icon projection for each desktop icon;
adjusting the desktop icon projection of each desktop icon according to the desktop icon projection parameters, to obtain a target desktop icon projection of each desktop icon; and
placing the target desktop icon projection of each desktop icon into the desktop background of the corresponding desktop icon.

18. The electronic equipment according to claim 15, wherein before the electronic equipment acquires desktop icon projection parameters of desktop icons on the desktop of the electronic equipment, if a desktop icon projection switch of the electronic equipment is turned on, the processor is also configured to:
update the icon projection parameters of the electronic equipment according to a user instruction; or
acquire desktop background parameters of each desktop icon coverage area, and update the icon projection parameters of the electronic equipment according to the desktop background parameters of each desktop icon coverage area.

19. The electronic equipment according to claim 15, wherein the desktop icon projection parameters comprise at least one of permeation value, resolution, offset value and radius of a desktop icon projection.

20. The electronic equipment according to claim 16, wherein the desktop icon projection parameters comprise at least one of permeation value, resolution, offset value and radius of a desktop icon projection.
